(19) United States
(12) Patent Application Publication
(10) Pub. No.: US 2026/0177210 A1
(43) Pub. Date: Jun. 25, 2026

(54) RELIEF VALVE PROTECTOR

(71) Applicant: George W. Smith, Spartanburg, SC (US)

(72) Inventor: George W. Smith, Spartanburg, SC (US)

(21) Appl. No.: 19/125,852

(22) PCT Filed: Oct. 31, 2023
(86) PCT No.: PCT/US2023/036355

§ 371 Date: Apr. 30, 2025

Related U.S. Application Data
(60) Provisional application No. 63/421,782, filed on Nov. 2, 2022.

(51) Int. Cl. F17C 13/12; F17C 1/00

(52) U.S. Cl. CPC F17C 13/126; F17C 1/007; F17C 2205/0332; F17C 2205/0352; F17C 2205/037; F17C 2221/035; F17C 2223/035; F17C 2270/0147

(57) ABSTRACT

A gas discharge safety system includes a gas conduit with one end connected to a pressurized tank and another end in communication with an outside environment. The gas conduit is arranged substantially perpendicular to the gas tank and above a head of a service technician such that pressurized gas that may escape from the tank will be safely discharged to the outside environment without endangering the technician.

This utility patent application claims priority to in international patent application number PCT/US23/36355 filed in the United States Patent and Trademark Office (“USPTO”) as the Receiving Office on Oct. 31, 2023, which claims benefit of U.S. Provisional Patent Application Ser. No. 63/421,782 filed in the United States Patent and Trademark Office on Nov. 2, 2022, both of which are incorporated by reference thereto in their entirety.

### BACKGROUND OF THE DISCLOSURE

Above and below ground gas tanks are well known. A below-ground propane tank, for instance, has fill and relief valves that extend above the surface for access by service technicians to fill the tank with liquid propane. Typically, the propane tank is filled to about 80% capacity to account for temperature fluctuation and gas expansion. The service valves may be at or near or directed toward a face level of the service technician while the technician is working. That conventional arrangement poses a danger to the technician if the relief valve discharges, which can occur suddenly to prevent a tank rupture due to an overfill condition or due to a defective valve. More particularly, since the temperature of liquid propane is forty-four degrees below zero Fahrenheit (−44° F.) (forty-two point two degrees below zero Celsius (−42.2° C.)) and pressurized at 250 pounds per square inch (psi), if the tank relief valve discharges, the discharged propane may strike the technician in the face or exposed skin and cause significant damage to eyes, skin, lungs, et cetera.

What is needed in the industry is a safety device for redirecting a gas discharge away from a service technician in the event of an overfill condition or due to defective equipment.

### BRIEF SUMMARY OF THE DISCLOSURE

The present disclosure is directed in general to a safety device that connects to an

external relief valve on a gas tank, such as a propane tank. The device is simple to make and easy to install and use while a gas tank is being serviced. In the event that the propane tank discharges, whether due to an overfill condition or a defective valve, the discharged gas will be directed safely away from the attending technician.

In one embodiment according to the disclosure, a gas discharge safety system may include a gas conduit having a first discharge end and a second attachment end spaced approximately sixty inches apart where the first discharge end is in open communication with an open-air environment; a boot having a first connection end and an opposing connection end, the first connection end being configured for connection to the second attachment end, and the opposing connection end being configured for connecting to a tank valve, the tank valve being in gaseous communication with a gas tank; and an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.

In this embodiment, the gas conduit may be a plastic pipe, vent, or tube. The gas conduit and the boot may be unitarily constructed, or they may be connected using a clamp.

In one example, an inner diameter of the first connection end may be larger than an inner diameter of the opposing connection end, and the adjustment mechanism may include a clamp and a thumbscrew in which the thumbscrew can be hand tightened to clamp the opposing connection end around the tank valve.

The tank in some embodiments may be a propane tank, which may be above ground or below ground, but the embodiments and their variations may be used with other types of tanks that store liquid and gas under extreme temperatures and pressures.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode

thereof directed to one of ordinary skill in the art, is set forth in the specification, which refers to the appended figures, wherein:

FIG. 1 is a partial, schematic, front elevational view of an embodiment of the disclosure;

FIG. 2 is partial perspective view of the embodiment as in FIG. 1, particularly showing a safety device being installed on a relief valve as found on a propane tank;

FIG. 3 is partial perspective view of the embodiment as in FIG. 2, particularly showing the safety device in an installed position;

FIG. 4 is a partial, close-up view of the embodiment as in FIG. 3, particularly showing an adjustable turnkey for connecting the safety device to the relief valve of the propane tank;

FIG. 5 is a partial, perspective view of another embodiment of the disclosure, particularly showing a safety device being installed on a valve of a below-ground tank (shown excavated for clarity); and

FIG. 6 is a partial, schematic, front elevational view of another embodiment of the disclosure.

### DETAILED DESCRIPTION OF THE DISCLOSURE

As required, detailed embodiments are disclosed herein; however, the disclosed

embodiments are merely exemplary and may be embodied in various forms. Therefore, specific structural and functional details disclosed herein are not to be interpreted as limiting, but as bases for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrases “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving a, b, and c” means that the method includes at least steps a, b, and c.

Where a list of alternative component terms is used, e.g., “a structure such as ‘a,’ ‘b,’ ‘c,’ ‘d,’ or the like,” or “a” or b,” such lists and alternative terms provide meaning and context for the sake of illustration, unless indicated otherwise. Also, relative terms such as “first,” “second,” “third,” “left,” “right,” “front,” “rear,” et cetera are intended to identify or distinguish one component or feature from another similar component or feature, unless indicated otherwise herein.

When a list of element names are provided with a component or step element number, the names are understood as identifying, nonlimiting, alternative nomenclature for that component or step; e.g., “bird, poultry, or fowl 10” means element number 10 may mean and be referred to by any of the listed nomenclature.

The various embodiments of the disclosure and/or equivalents falling within the scope of the present disclosure overcome or ameliorate at least one of the disadvantages of the prior art.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

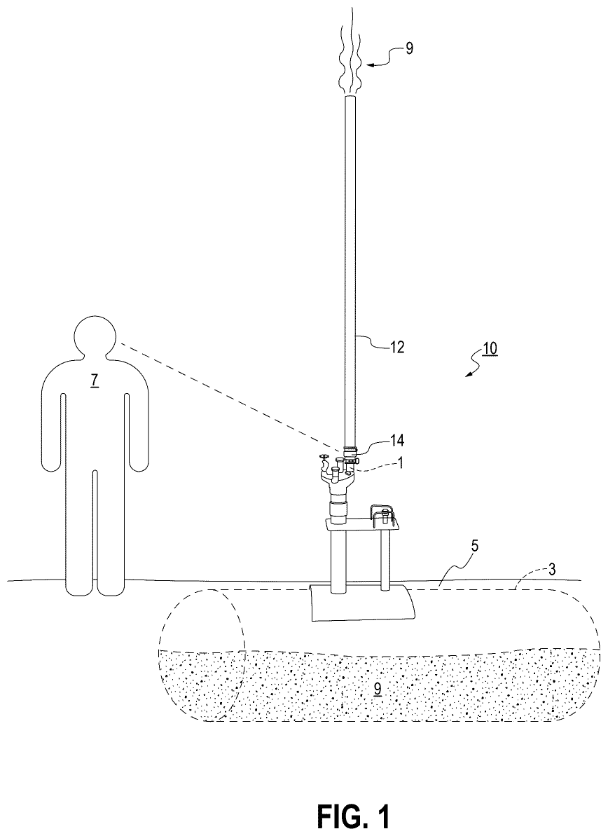

Turning now to FIG. 1, an exemplary GC99 Relief Valve Protection System is designated broadly by the element number 10. As shown, the safety system 10 may include a pipe, conduit, or tube 12 and a fitting, connector, or boot 14 connected to a relief valve 1 of a gas tank 3, which is under ground 5 in this example, although the tank 3 can be above ground. As explained in detail below, the system 10 permits a technician 7 to service the tank 3 such as by filling it with liquid propane 9, which is under pressure at approximately 250 psi and at a temperature of approximately 44° F. below zero (−42.2° C.). Although the tank 3 will usually be filled to about 80% capacity and considered “full” to account for temperature fluctuations and expansion of the liquid propane 9, in the event of an overfill, the relief valve 1 will activate to evacuate the propane 9 to prevent a rupture in the tank 3 that could possibly result in a gas explosion. Without the system 10 in place, if the relief valve 1 activates or if there is an equipment failure, the technician 7 could be in danger of being struck by the evacuating propane 9, which could severely injure or kill the technician 7. Here, however, the propane 9 will discharge through a discharge end of the tube 12 well above a head of the technician 7, even if he is standing as shown. Therefore, the tube 12 may be at least six feet (6 ft.) (one point eight meters (1.8 m) in length, although shorter or longer tubes 12 may be provided. Further, two or more tubes 12 may be attached together to create an extra-long discharge tube 12 under certain circumstances.

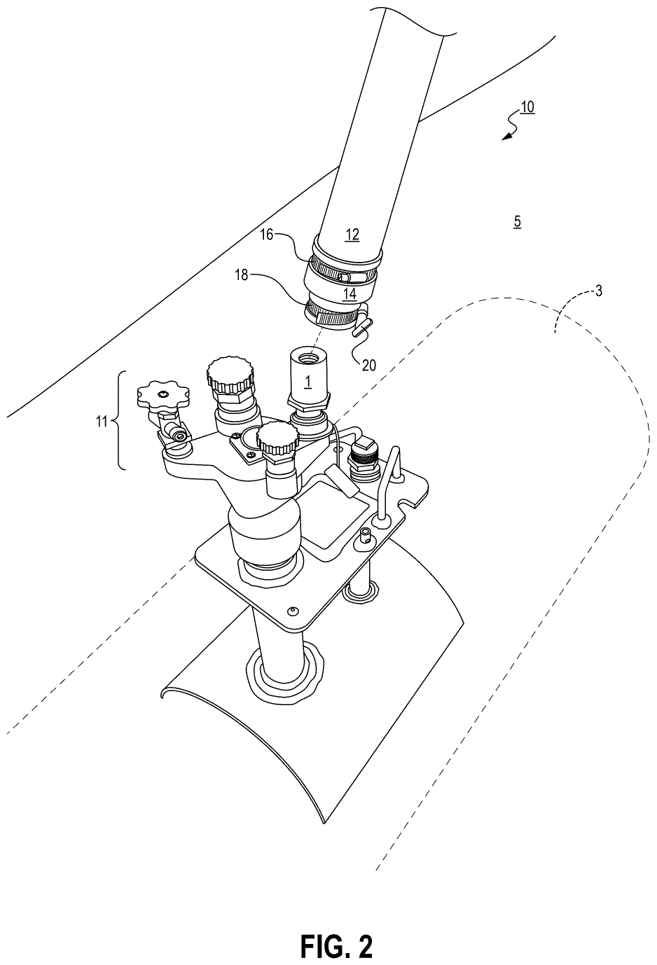

Turning to FIG. 2 the safety system 10 is shown in a first state or intermediate condition in which it is about to be installed on the relief valve 1 of the tank 3. Here, the valve 1 is located near standard fill and flow valves 11 with the exemplary tank 3 located directly below the valves 1, 11 and beneath the surface 5. As briefly introduced above, the tube 12 and the boot 14 are connected to each other using a band or clamp 16 in this example. Also in this exemplary embodiment, the tube 12 may be any suitable pipe for handling compressed gas, such as O.C.P.I. two-inch (2″) SCH 40 Ridge polyvinyl chloride (PVC) for underground and above ground use. More particularly, the tube 12 may be UL-051/NEMA TC-2 standard maximum 90 degree Celsius (90° C.) rated, wire sunlight resistant 8121B PVC pipe. Also in this example, the tube 12 is approximately sixty inches (60 in.) (one hundred and fifty-two point four centimeters (152.5 cm)) in length and two inches (2 in.) (˜5.1 cm) in diameter to extend a discharge opening for gas 9 well above a head of a standing technician (see FIG. 1). Likewise, the boot 14 at one end may be approximately two inches (2 in.) in diameter to fit the tube 12, and at another end approximately one and one-half inches (1½ in.) (3.8 cm) in diameter to fit around the relief valve 1. The boot 14 may be made of UPC Ideal Tridon 300SS. Thus, the boot 14 can be fitted to the tube 12 using the clamp 16 with a 5/16 in. (12.7 cm) screwhead, or the tube 12 and the boot 14 could be unitarily formed without need of the exemplary clamp 16.

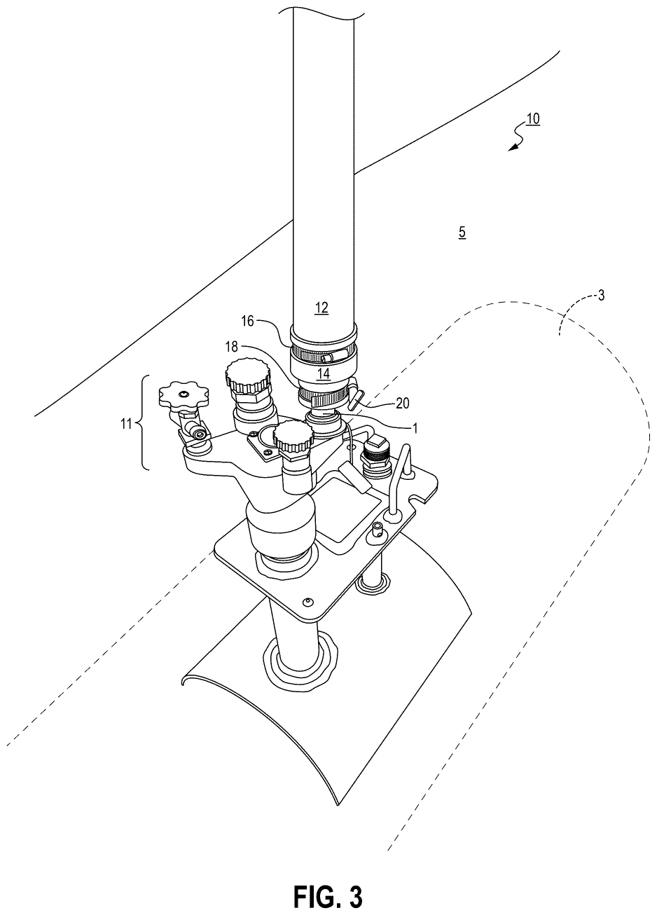

FIG. 2 further shows that another clamp, coupling, or button band 18 with a thumbscrew 20 can be fitted to the 1½ in. end of the boot 14. As shown and explained by exemplary operation below, the technician places the boot 14 over the relief valve 1 and turns the thumbscrew 20 until the system 10 is upright and tightened in position to begin servicing the tank 3, as shown in FIG. 3 in a second state or installed condition.

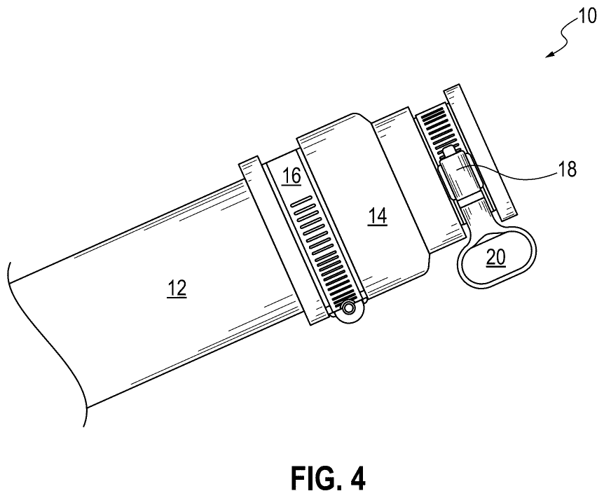

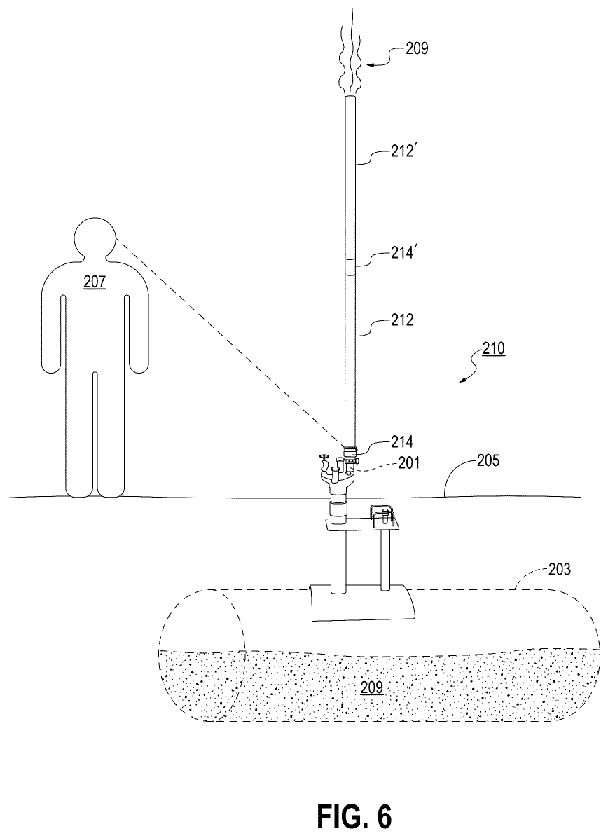

The thumbscrew 20 introduced above is shown in FIG. 4 in further detail. Here, the exemplary clamp 18 is a metal, 70 mm (2.76 in.) clamp with a Colliers 5Y00158 turnkey being used as the thumbscrew 20 to connect the safety system 10 to a relief valve 1 as described above. Those skilled in the art will appreciate that the boot 14 can be configured to include a snap or press fit assembly, rather than or in addition to the thumbscrew 20, whereby the boot 14 locks into or around the valve 1. In some circumstances, another boot 14 may be used to connect together two gas conduits or tubes 12 if an extended length safety system 10 is required. See, e.g., FIG. 6.

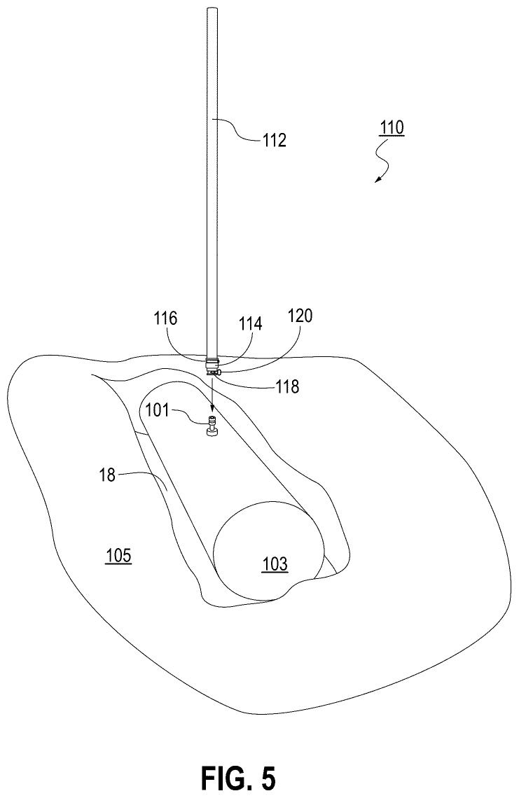

By way of exemplary operation with reference to FIG. 5, steps that a technician may take to employ a safety system 110 may include:
1. Approaching a tank 103 with caution, particularly an area with exposed valves such as a tank relief valve 101.
2. Orienting a GC99 Relief Valve Protection System 110 with an evacuation tube 112 facing upwards and an attached connector 114 facing downwards toward the tank 103.
3. With a top portion (discharge end) of the system 110 directed away from face and body—ensuring that all body parts are below the top of the system 110—carefully placing the connector 114 on a tank relief valve 101 with a top strap or band 116 tightened but a button band, ring, coupling, or strap 118 being sufficiently loose to fit over the relief valve 101.
4. Firmly seating the coupling 118 on the relief valve 101 and hand tightening a turnkey collar 120 to secure the coupling 118 onto the relief valve 101. At all times, a technician and anyone in close proximity should be below and away from the top discharge end of the system 110.
5. Evacuating excess propane from the tank 103 by opening a discharge valve or the relief valve 101.
6. Once the tank 103 is evacuated, removing the system 110 from the relief valve 101 by loosening the turnkey collar 120.

Turning now to FIG. 6, an exemplary GC99 Relief Valve Protection System is designated broadly by the element number 210. As shown, the safety system 210 may include a pipe, conduit, or tube 212 and a fitting, connector, or boot 214 connected to a relief valve 201 of a gas tank 203, which is under ground 205 in this example, although the tank 203 can be above ground. As explained in detail below, the system 210 permits a technician 207 to service the tank 203 by, for example, filling it with liquid propane 209, which is under pressure at approximately 250 psi and at a temperature of approximately 44° F. below zero (−42.2° C.). Although the tank 203 will usually be filled to about eighty percent (80%) capacity and considered “full” to account for temperature fluctuations and expansion of the liquid propane 209, in the event of an overfill, the relief valve 201 will activate to evacuate the propane 209 to prevent a rupture in the tank 203 that could possibly result in a gas explosion. Here, however, the propane 209 will discharge through the discharge end of the tube 212 well above a head of the technician 207, even if he is standing near the valve 201 as shown. Therefore, the tube 212 may be at least six feet (6 ft.) (one point eight meters (1.8 m) in length, although shorter or longer tubes 212 may be provided. Further, two or more tubes 212, 212′ may be attached together using another boot 214′ to create an extended length gas conduit. Whether one or multiple tubes 212, 212′ are utilized, once installed and in gaseous communication with the tank 203, the gas discharge end (see escaping gas 209) will be inaccessible to human contact when the opposing connection end (see boot 214) is connected to the tank valve 201.

Exemplary embodiments as disclosed herein may include but are not limited to:

EMBODIMENT 1: A gas discharge safety system, comprising a gas conduit having a first discharge end and a second attachment end, the first discharge end being in open communication with an open-air environment; a boot having a first connection end and an opposing connection end, the first connection end being configured for connection to the second attachment end, and the opposing connection end being configured for connecting to a tank valve, the tank valve being in gaseous communication with a gas tank; and an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.

EMBODIMENT 2: The gas discharge safety system as in embodiment 1, wherein the first discharge end is spaced at least sixty inches from the second attachment end.

EMBODIMENT 3: The gas discharge safety system as in embodiments 1 or 2, wherein the gas conduit is a plastic pipe approximately 6 feet or (1.8 meters) in length.

EMBODIMENT 4: The gas discharge safety system as in embodiments 1 through 3, wherein the gas conduit and the boot are unitarily constructed.

EMBODIMENT 5: The gas discharge safety system as in any of the foregoing embodiments, wherein an inner diameter of the first connection end is larger than an inner diameter of the opposing connection end.

EMBODIMENT 7: The gas discharge safety system as in any of the foregoing embodiments, wherein the adjustment mechanism includes a clamp and a thumbscrew, the thumbscrew being configured to hand tighten the clamp to tighten the opposing connection end around the tank valve.

EMBODIMENT 8: The gas discharge safety system as in any of the foregoing embodiments, wherein the tank is a propane tank.

EMBODIMENT 9: The gas discharge safety system as in any of the foregoing embodiments, wherein the tank is above ground or below ground.

EMBODIMENT 10: A gas discharge safety system, comprising a gas conduit having a first discharge end and a second attachment end, the first discharge end being in open communication with an open-air environment; and a boot having a first connection end and an opposing connection end, the first connection end being configured for connection to the second attachment end, and the opposing connection end being configured for connecting to a tank valve, the tank valve being in gaseous communication with a gas tank, the first discharge end being inaccessible to human contact when the opposing connection end is connected to the tank valve.

EMBODIMENT 11: The gas discharge safety system as in Embodiment 10, further comprising an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A gas discharge safety system, comprising:
a gas conduit having a first discharge end and a second attachment end, the first discharge end being in open communication with an open-air environment;
a boot having a first connection end and an opposing connection end, the first connection end being configured for connection to the second attachment end, and the opposing connection end being configured for connecting to a tank valve, the tank valve being in gaseous communication with a gas tank; and
an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.

2. The gas discharge safety system as in claim 1, wherein the first discharge end is spaced at least sixty inches from the second attachment end.

3. The gas discharge safety system as in claim 1, wherein the gas conduit is a pipe.

4. The gas discharge safety system as in claim 1, wherein the gas conduit and the boot are unitarily constructed.

5. The gas discharge safety system as in claim 1, wherein an inner diameter of the first connection end is larger than an inner diameter of the opposing connection end.

6. The gas discharge safety system as in claim 1, wherein the adjustment mechanism includes a clamp and a thumbscrew, the thumbscrew being configured to hand tighten the clamp to tighten the opposing connection end around the tank valve.

7. The gas discharge safety system as in claim 1, wherein the tank is a propane tank.

8. The gas discharge safety system as in claim 1, wherein the tank is disposed above ground.

9. The gas discharge safety system as in claim 1, wherein the tank is disposed below ground.

10. A gas discharge safety system, comprising:
a gas conduit having a first discharge end and a second attachment end, the first discharge end being in open communication with an open-air environment;
a boot having a first connection end and an opposing connection end, the first connection end being configured for connection to the second attachment end, and the opposing connection end being configured for connecting to a tank valve or to a second gas conduit, the tank valve being in gaseous communication with a gas tank; and
an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.

11. The gas discharge safety system as in claim 10, wherein the gas conduit is a plastic pipe.

12. The gas discharge safety system as in claim 10, wherein the gas conduit and second gas conduit are attached together to form an extended length gas conduit.

13. A gas discharge safety system, comprising:
a gas conduit having a first discharge end and a second attachment end, the first discharge end being in open communication with an open-air environment; and
a boot having a first connection end and an opposing connection end, the first connection end being configured for connection to the second attachment end, and the opposing connection end being configured for connecting to a tank valve, the tank valve being in gaseous communication with a gas tank, the first discharge end being inaccessible to human contact when the opposing connection end is connected to the tank valve.

14. The gas discharge safety system as in claim 13, further comprising an adjustment mechanism attached to the opposing connection end and configured to tighten the opposing connection end around the tank valve, wherein when the opposing connection end is tightened around the tank valve, the gas conduit is arranged substantially orthogonally to the gas tank and gas within the gas tank is evacuated via the tank valve and discharged to the open-air environment and away from bystanders.
